(19) United States
(12) Patent Application Publication
(10) Pub. No.: US 2022/0400824 A1
(43) Pub. Date: Dec. 22, 2022

(54) THREE-PROOF EARBUDS BOX PROTECTIVE CASE

(71) Applicant: Jun Zhang, Guangdong (CN)

(72) Inventor: Jun Zhang, Guangdong (CN)

(21) Appl. No.: 17/620,751

(22) PCT Filed: Dec. 23, 2019
(86) PCT No.: PCT/CN2019/127319

§ 371 Date: Dec. 20, 2021

(30) Foreign Application Priority Data
Jun. 19, 2019 (CN) 201920929186.7

(51) Int. Cl. A45C 11/00; A45C 13/00; A45C 13/10

(52) U.S. Cl. CPC A45C 11/00; A45C 13/005; A45C 13/1084; A45C 2011/001; H04R 2460/17; H04R 1/1091

(57) ABSTRACT

A three-proof earbuds box protective case includes a bottom housing and a top cover mounted at the upper end of the bottom housing and can be opened or closed. One side of the bottom housing and one side of the top cover are hinged. A waterproof and dustproof ring is provided between the bottom housing and the top cover. The lower end of the bottom housing has a first shockproof flexible rubber having a first shockproof part fixed to the lower end surface of the bottom housing, and a second shockproof part fixed to the inner wall of the bottom housing. The upper end of the top cover has a second shockproof flexible rubber having a third shockproof part fixed to the upper end surface of the top cover, and a fourth shockproof part fixed to the inner wall of the top cover.

### TECHNICAL FIELD

The present invention relates to the technical field of protective case products, in particular to three-proof earbuds box protective case.

### DESCRIPTION OF RELATED ART

With the consumption upgrade, wireless earbuds are favored by consumers because of their compact size and portability. In order to store wireless earbuds to avoid losing and to charge wireless earbuds, they are typically placed in earbuds boxes.

When being carried, these earbuds boxes will unavoidably bump, which will easily scratch the earbuds boxes and negatively affect the appearance of the earbuds boxes. Given this problem, earbuds box protective cases have appeared on the market, which can protect the earbuds box from being scratched. An earbuds box protective case generally comprises a bottom housing and an upper cover, the bottom housing is covered over the lower end of the case, the top cover is covered over the upper end of the earbuds box, and the bottom housing and the top cover are in contact with each other. There is no connection structure between the bottom housing and the top cover of the earbuds box of this structure, which makes the bottom housing and the top cover easily separate from the earbuds box when being bumped. The waterproof and dustproof effect between the bottom housing and the top cover is extremely poor, and the bottom housing and the top cover are also not shockproof.

In view of this, the inventor proposes the following technical solution.

### SUMMARY

The object of the present invention is to overcome the shortcomings of the prior art and to provide a three-proof earbuds box protective case.

In order to solve the above-mentioned technical problem, the present invention adopts the following technical solution. A three-proof earbuds box protective case includes a bottom housing and a top cover which is mounted at the upper end of the bottom housing and can be opened or closed relative to the bottom housing. A storage space for storing the earbuds box is formed between the bottom housing and the top cover. One side of the bottom housing and one side of the top cover are hinged by a first shaft body in cooperation with a torsion spring, and another side of the bottom housing is provided with a locking catch for clamping and positioning the top cover. A waterproof and dustproof ring is provided between the bottom housing and the top cover. The lower end of the bottom housing is provided with a first shockproof flexible rubber. A first shockproof part of the first shockproof flexible rubber is fixed to the lower end surface of the bottom housing, and a second shockproof part of the first shockproof flexible rubber is fixed to the inner wall of the bottom housing. The upper end of the top cover is provided with a second shockproof flexible rubber. A third shockproof part of the second shockproof flexible rubber is fixed to the upper end surface of the top cover, and a fourth shockproof part of the second shockproof flexible rubber is fixed to the inner wall of the top cover.

Further, in the above technical proposal, a locking seat is formed on the another side of the top cover, and a locking groove is arranged on the side surface of the locking seat. The another side of the bottom housing is formed with a pin joint seat corresponding to the locking seat, the locking catch is pin-jointed to the pin joint seat through a second shaft body, and a locking protrusion adapted to the locking groove is formed on the side surface of the upper end of the locking catch, and the locking protrusion is fitted and fixed in the locking groove.

Furthermore, in the above technical solution, a locking ring is further hinged to the pin joint seat, and the locking ring is snap-fitted and fixed to the upper end of the locking seat.

Furthermore, in the above technical solution, a clearance recess is provided on the side of the pin joint seat, and the lower end of the locking catch protrudes and is exposed from the clearance recess.

Furthermore, in the above technical solution, a first ring groove is provided at the edge of the upper end of the bottom housing, and a second ring groove adapted to the first ring groove is provided at the edge of the lower end of the top cover, the waterproof and dustproof ring is compressed and positioned in the first ring groove and the second ring groove.

Furthermore, in the above technical solution, the first shockproof flexible rubber comprises a first body part, the second shockproof part and the first shockproof part formed at the upper end and the lower end of the first body part, the upper end of the first body part is further formed with a fifth shockproof part, and the inner side of the fifth shockproof part is exposed on the inner wall of the bottom housing.

Furthermore, in the above technical solution, the second shockproof flexible rubber comprises a second body part, the third shockproof part and the fourth shockproof part formed at the upper end and the lower end of the first body part.

Furthermore, in the above technical solution, the first shockproof flexible rubber is integrally fixed at the lower end of the bottom housing using over molding. The second shockproof flexible rubber is integrally fixed at the upper end of the top cover using over molding.

Furthermore, in the above technical solution, both the first shockproof flexible rubber and the second shockproof flexible rubber are made of TPE or TPU materials.

Furthermore, in the above technical solution, both the bottom housing and the top cover are made of PC material.

By adopting the above technical solution, as compared to the prior art, the present invention has the following beneficial effect: one side of the bottom housing in the present invention and one side of the top cover are hinged by a first shaft body in cooperation with a torsion spring, so that when the top cover is opened relative to the bottom housing, the torsion spring provides elastic force for the opening of the top cover, thus allowing smoother opening of the top cover. The other side of the bottom housing is provided with a locking catch for clamping and positioning the top cover, so that after the top cover is closed to the upper end of the bottom housing, the top cover is locked to the upper end of the bottom housing through the locking catch, which ensures the stability of the assembled structure of the top cover and the bottom housing, preventing the top cover from accidentally separating from the bottom housing, thereby better protecting the earbuds box. A waterproof and dustproof ring is provided between the bottom housing and the top cover to bring the bottom housing and the top cover into sealing contact, so that the present invention has excellent dustproof and waterproof effects. The first shockproof flexible rubber and the second shockproof flexible rubber added in the present invention respectively make the bottom housing and the top cover both have an excellent shockproof effect, so that the present invention has an excellent shockproof effect.

### BRIEF DESCRIPTION OF THE DRAWINGS

FIG. 1 is a perspective view of the present invention;

FIG. 2 is a perspective view of the present invention from another angle;

FIG. 3 is a perspective exploded view of the present invention; and

FIG. 4 is a sectional view of the present invention.

### DESCRIPTION OF THE EMBODIMENTS

The present invention is further described below in conjunction with specific embodiments and the accompanying drawings.

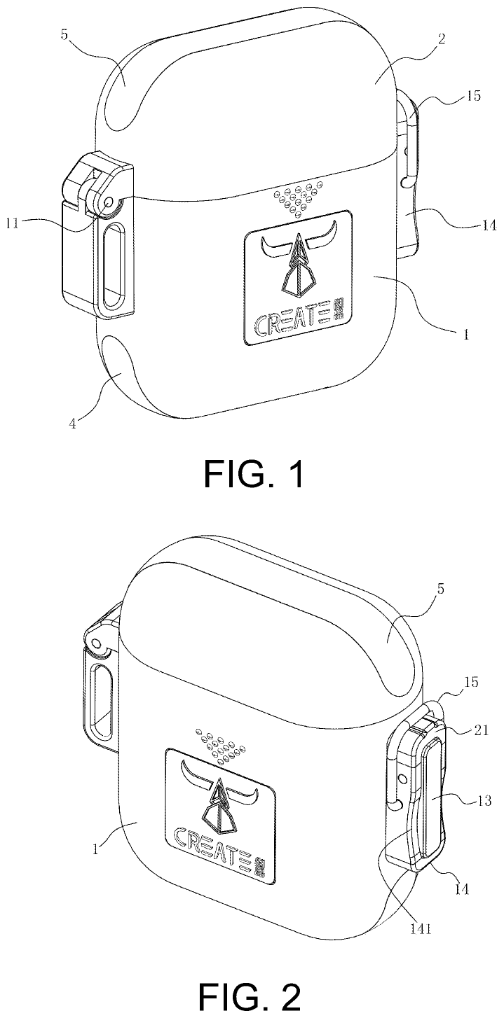

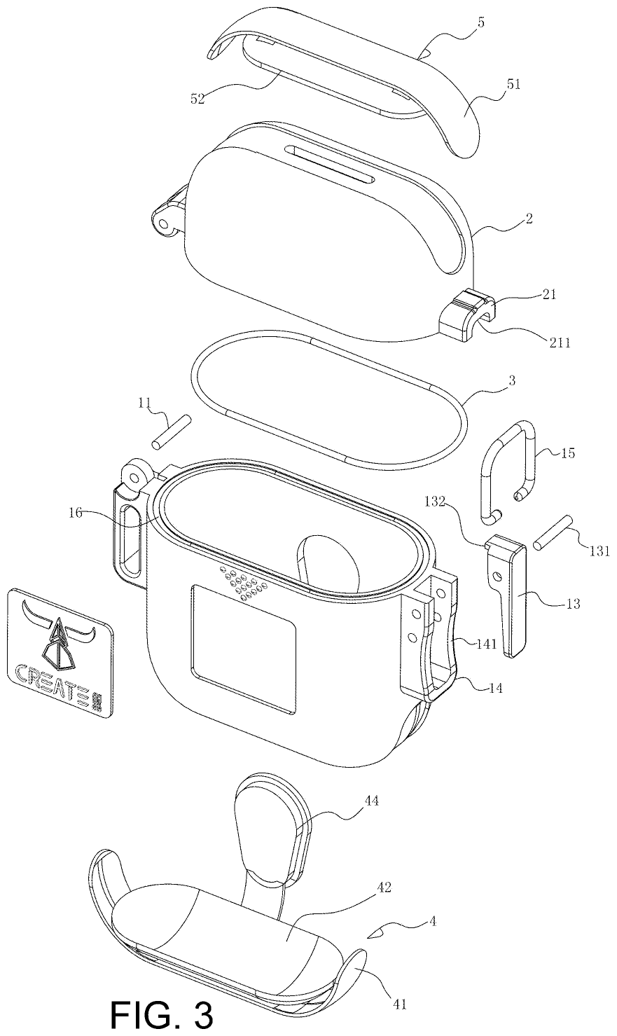

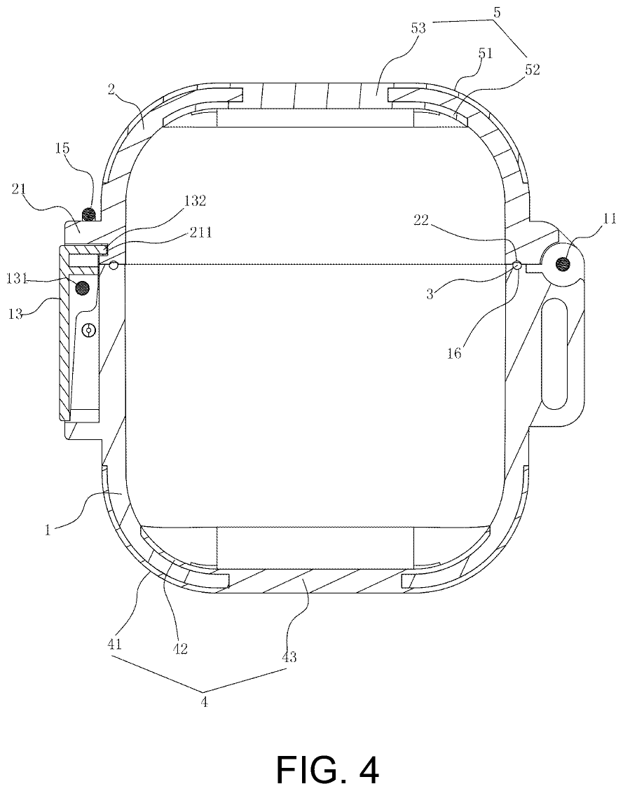

As shown in FIGS. 1-4, a three-proof earbuds box protective case is shown. The three-proof earbuds box protective case includes a bottom housing 1 and a top cover 2 which is mounted at the upper end of the bottom housing 1 and can be opened or closed relative to the bottom housing 1. A storage space for storing the earbuds box is formed between the bottom housing 1 and the top cover 2. One side of the bottom housing 1 and one side of the top cover 2 are hinged by a first shaft body 11 in cooperation with a torsion spring, so that when the top cover 2 is opened relative to the bottom housing 1, the torsion spring provides elastic force for the opening of the top cover 2, thus allowing smoother opening of the top cover 2. Another other side of the bottom housing 1 is provided with a locking catch 13 for clamping and positioning the top cover 2, so that after the top cover 2 is closed to the upper end of the bottom housing 1, the top cover 2 is locked to the upper end of the bottom housing 1 through the locking catch 13, which ensures the stability of the assembled structure of the top cover 2 and the bottom housing 1, preventing the top cover 2 from accidentally separating from the bottom housing 1, thereby better protecting the earbuds box. A waterproof and dustproof ring 3 is provided between the bottom housing 1 and the top cover 2 to bring the bottom housing 1 and the top cover 2 into sealing contact, so that the present invention has excellent dustproof and waterproof effects. The lower end of the bottom housing 1 is provided with a first shockproof flexible rubber 4. A first shockproof part 41 of the first shockproof flexible rubber 4 is fixed to the lower end surface of the bottom housing 1, and a second shockproof part 42 of the first shockproof flexible rubber 4 is fixed to the inner wall of the bottom housing 1 for contacting with the earbuds box. The upper end of the top cover 2 is provided with a second shockproof flexible rubber 5. A third shockproof part 51 of the second shockproof flexible rubber 5 is fixed to the upper end surface of the top cover 2, and a fourth shockproof part 52 of the second shockproof flexible rubber 5 is fixed to the inner wall of the top cover 2 for contacting with the earbuds box. The first shockproof flexible rubber 4 and the second shockproof flexible rubber 5 added in the present invention respectively make the bottom housing 1 and the top cover 2 both have an excellent shockproof effect, so that the present invention has an excellent shockproof effect.

A locking seat 21 is formed on another side of the top cover 2, and a locking groove 211 is provided on the side of the locking seat 21. The another side of the bottom housing 1 is formed with a pin joint seat 14 corresponding to the locking seat 21. The locking catch 13 is pin-jointed to the pin joint seat 14 through a second shaft body 131. A locking protrusion 132 adapted to the locking groove 211 is formed on the side surface of the upper end of the locking catch 13, and the locking protrusion 132 is fitted and fixed in the locking groove 211, so as to ensure the stable assembly of the locking catch 13 and the top cover 2, so that the top cover 2 is fixed to the upper end of the bottom housing 1, and the locking catch 13 is more tactile when pressed and is more effectual.

A locking ring 15 is further hinged to the pin joint seat 14, and the locking ring 15 is snap-fitted and fixed to the upper end of the locking seat 21, so as to achieve the effect of double locking, which can effectively prevent the top cover 2 from accidentally opening relative to the bottom housing 1, and make the assembled structure more stable.

A clearance recess 141 is provided on the side of the pin joint seat 14, and the lower end of the locking catch 13 protrudes and is exposed from the clearance recess 141, so that the locking catch 13 can be pushed down more conveniently to separate the locking catch 13 from the top cover 2.

A first ring groove 16 is provided at the edge of the upper end of the bottom housing 1, and a second ring groove 22 adapted to the first ring groove 16 is provided at the edge of the lower end of the top cover 2. The waterproof and dustproof ring 3 is compressed and positioned in the first ring groove 16 and the second ring groove 22.

The first shockproof flexible rubber 4 comprises a first body part 43, the second shockproof part 42 formed at the upper end of the first body part 43, and the first shockproof part 41 formed at the lower end of the first body part 43. The upper end of the first body part 43 is further formed with a fifth shockproof part 44, and the inner side of the fifth shockproof part 44 is exposed on the inner wall of the bottom housing 1 for contact with the earbuds box to further improve the shockproof effect.

The second shockproof flexible rubber 5 comprises a second body part 53, the third shockproof part 51 formed at the upper end of the first body part 43 and the fourth shockproof part 52 formed at the lower end of the first body part 43.

The first shockproof flexible rubber 4 is integrally fixed at the lower end of the bottom housing 1 using over molding. The second shockproof flexible rubber 5 is integrally fixed at the upper end of the top cover 2 using over molding, which structure is extremely stable.

Both the first shockproof flexible rubber 4 and the second shockproof flexible rubber 5 are made of TPE or TPU materials, and the shockproof effect is extremely ideal.

Both the bottom housing 1 and the top cover 2 are made of PC material.

In summary, one side of the bottom housing 1 and one side of the top cover 2 are hinged by a first shaft body 11 in cooperation with a torsion spring, so that when the top cover 2 is opened relative to the bottom housing 1, the torsion spring provides elastic force for the opening of the top cover 2, thereby allowing smoother opening of the top cover 2. Another side of the bottom housing 1 is provided with a locking catch 13 for clamping and positioning the top cover 2, so that after the top cover 2 is closed to the upper end of the bottom housing 1, the top cover 2 is locked to the upper end of the bottom housing 1 through the locking catch 13, which ensures the stability of the assembled structure of the top cover 2 and the bottom housing 1, preventing the top cover 2 from accidentally separating from the bottom housing 1, thereby better protecting the earbuds box. A waterproof and dustproof ring 3 is provided between the bottom housing 1 and the top cover 2 to bring the bottom housing 1 and the top cover 2 into sealing contact, so that the present invention has excellent dustproof and waterproof effects. The lower end of the bottom housing 1 is provided with a first shockproof flexible rubber 4. A first shockproof part 41 of the first shockproof flexible rubber 4 is fixed to the lower end surface of the bottom housing 1, and a second shockproof part 42 of the first shockproof flexible rubber 4 is fixed to the inner wall of the bottom housing 1 for contacting with the earbuds box. The upper end of the top cover 2 is provided with a second shockproof flexible rubber 5. A third shockproof part 51 of the second shockproof flexible rubber 5 is fixed to the upper end surface of the top cover 2, and a fourth shockproof part 52 of the second shockproof flexible rubber 5 is fixed to the inner wall of the top cover 2 for contacting with the earbuds box. The first shockproof flexible rubber 4 and the second shockproof flexible rubber 5 added in the present invention respectively make the bottom housing 1 and the top cover 2 both have an excellent shockproof effect, so that the present invention has an excellent shockproof effect.

It is apparent that the above are only specific embodiments of the present invention, and is not intended to limit the embodiment scope of the present invention. Any equivalent changes or modifications made according to the structure, features and principles described in the patent scope of the present invention application shall be contained in the patent scope of the present invention application.

1. A three-proof earbuds box protective case, comprising a bottom housing and a top cover which is mounted at an upper end of the bottom housing and is able to be opened or closed relative to the bottom housing, wherein a storage space for storing an earbuds box is formed between the bottom housing and the top cover,
one side of the bottom housing and one side of the top cover are hinged by a first shaft body in cooperation with a torsion spring; another side of the bottom housing is provided with a locking catch for clamping and positioning the top cover; a waterproof and dustproof ring is provided between the bottom housing and the top cover, a lower end of the bottom housing is provided with a first shockproof flexible rubber, a first shockproof part of the first shockproof flexible rubber is fixed to a lower end surface of the bottom housing, and a second shockproof part of the first shockproof flexible rubber is fixed to an inner wall of the bottom housing; an upper end of the top cover is provided with a second shockproof flexible rubber, a third shockproof part of the second shockproof flexible rubber is fixed to an upper end surface of the top cover, and a fourth shockproof part of the second shockproof flexible rubber is fixed to an inner wall of the top cover.

2. The three-proof earbuds box protective case according to claim 1, wherein a locking seat is formed on another side of the top cover, and a locking groove is provided on a side of the locking seat; the another side of the bottom housing is formed with a pin joint seat corresponding to the locking seat, the locking catch is pin-jointed to the pin joint seat through a second shaft body, and a locking protrusion adapted to the locking groove is formed on a side surface of an upper end of the locking catch, and the locking protrusion is fitted and fixed in the locking groove.

3. The three-proof earbuds box protective case according to claim 2, wherein a locking ring is further hinged to the pin joint seat, and the locking ring is snap-fitted and fixed to the upper end of the locking seat.

4. The three-proof earbuds box protective case according to claim 2, wherein a clearance recess is provided on a side of the pin joint seat, and a lower end of the locking catch protrudes and is exposed from the clearance recess.

5. The three-proof earbuds box protective case according to claim 1, wherein a first ring groove is provided at an edge of the upper end of the bottom housing, and a second ring groove adapted to the first ring groove is provided at an edge of the lower end of the top cover, the waterproof and dustproof ring is compressed and positioned in the first ring groove and the second ring groove.

6. The three-proof earbuds box protective case according to claim 5, wherein the first shockproof flexible rubber comprises a first body part, the second shockproof part formed at an upper end of the first body part, and the first shockproof part formed at a lower end of the first body part, the upper end of the first body part is further formed with a fifth shockproof part, and an inner side of the fifth shockproof part is exposed on the inner wall of the bottom housing.

7. The three-proof earbuds box protective case according to claim 5, wherein the second shockproof flexible rubber comprises a second body part, the third shockproof part and the fourth shockproof part formed at the upper end and the lower end of the second body part.

8. The three-proof earbuds box protective case according to claim 5, wherein the first shockproof flexible rubber is integrally fixed at the lower end of the bottom housing using over molding; the second shockproof flexible rubber is integrally fixed at the upper end of the top cover using over molding.

9. The three-proof earbuds box protective case according to claim 5, wherein both the first shockproof flexible rubber and the second shockproof flexible rubber are made of thermoplastic elastomers (TPE) or thermoplastic polyurethane(TPU) materials.

10. The three-proof earbuds box protective case according to claim 5, wherein both the bottom housing and the top cover are made of PC material.
